(19) United States
(12) Patent Application Publication
(10) Pub. No.: US 2020/0086441 A1
(43) Pub. Date: Mar. 19, 2020

(54) MDOF MICRO-LUBRICATION INTELLIGENT SPRAY HEAD SYSTEM FOR CNC MILLING MACHINE

(71) Applicants: QINGDAO UNIVERSITY OF TECHNOLOGY, Qingdao (CN); SHANGHAI JINZHAO ENERGY SAVING TECHNOLOGY CO., LTD, Shanghai (CN)

(72) Inventors: Changhe LI, Qingdao (CN); Menghua SUI, Qingdao (CN); Wentao WU, Qingdao (CN); Naiqing ZHANG, Qingdao (CN); Qidong WU, Qingdao (CN); Jun LI, Qingdao (CN); Zhiguang HAN, Qingdao (CN); Heju JI, Qingdao (CN); Teng GAO, Qingdao (CN); Yanbin ZHANG, Qingdao (CN); Min YANG, Qingdao (CN); Dongzhou JIA, Qingdao (CN); Qingan YIN, Qingdao (CN); Xiaoyang ZHANG, Qingdao (CN); Yali HOU, Qingdao (CN)

(73) Assignees: QINGDAO UNIVERSITY OF TECHNOLOGY; SHANGHAI JINZHAO ENERGY SAVING TECHNOLOGY CO., LTD

(21) Appl. No.: 16/692,159

(22) Filed: Nov. 22, 2019

Related U.S. Application Data
(63) Continuation of application No. PCT/CN2018/119446, filed on Dec. 6, 2018.

(30) Foreign Application Priority Data
Jul. 2, 2018 (CN) 201810707515.3

(51) Int. Cl. B23Q 11/12; B05B 3/02

(52) U.S. Cl. CPC B23Q 11/122; B05B 3/025

(57) ABSTRACT

The present invention discloses an MDOF (multi-degree-of-freedom) micro-lubrication intelligent spray head system for a CNC milling machine, comprising an annular rotating platform, a longitudinal telescopic part, a rotating part, an intelligent spray head mounting platform and an information acquisition system. The annular rotating platform comprises a rotating piece which rotates along a horizontal circumferential direction; a bottom of the rotating piece is connected with at least one longitudinal telescopic part; a lower end of the longitudinal telescopic part is connected with the rotating part; the rotating part rotates within a set angle range by taking a point connected with the longitudinal telescopic part as an axis; the intelligent spray head mounting platform is connected with the rotating part and moves along with the rotating part; and the information acquisition system is mounted on the intelligent spray head mounting platform.

### CROSS-REFERENCE TO RELATED APPLICATIONS

This application is a continuation of International Patent Application No. PCT/CN2018/119446 with a filing date of Dec. 6, 2018, designating the United States, now pending, and further claims priority to Chinese Patent Application No. 201810707515.3 with a filing date of Jul. 2, 2018. The content of the aforementioned applications, including any intervening amendments thereto, are incorporated herein by reference.

### TECHNICAL FIELD

The present invention belongs to the field of metal processing, and particularly relates to an MDOF (multi-degree-of-freedom) micro-lubrication intelligent spray head system for assisting a CNC milling machine.

### BACKGROUND OF THE PRESENT INVENTION

A machining region is cooled and lubricated by a large amount of emulsion, cutting oil, coolant and the like in traditional machining. The cooling and lubricating mode has a low utilization rate and increases huge machining and production costs. Moreover, the scrapped coolant may cause great damage to the environment if not handled properly. Dry machining technology is an earliest green and environment-friendly machining technology, is originated from the automobile industry, has been successfully applied to machining such as turning, milling, drilling and boring, does not simply abandon cutting fluid completely, but abolishes the use of the cutting fluid on the premise of ensuring the machining accuracy of parts and the service life of cutters. However, the dry machining technology does not solve the problem of cooling of the cutting region, and causes surface burning, deterioration of surface integrity and other problems of workpieces.

Micro-lubrication technology has an inevitable trend to replace pouring emulsion and the dry machining technology, adapts to a concept of green manufacturing and sustainable development, and refers to a technology in which a trace amount of lubricating liquid, water and air with a certain pressure are mixed and atomized and then sprayed into the cutting region to play a cooling and lubricating role. The water and the high-pressure air play a cooling role, while oil plays roles of lubricating the cutting region and prolonging the service life of the cutters. At present, some progress has been made in research of the micro-lubrication technology. The design and development of micro-lubrication equipment has become an important part for realizing the micro-lubrication technology. Although many designers have designed micro-lubrication systems, many problems still exist in practical application.

The micro-lubrication equipment has been researched in depth in the prior art. A nano-particle jet micro-lubrication grinding three-phase flow supply system is designed and is characterized in that nano-fluid is conveyed to a spray nozzle through a liquid path; meanwhile, the high-pressure air enters the spray nozzle through an air path; the high-pressure air and the nano-fluid are fully mixed and atomized in a mixing chamber of the spray nozzle and enter a vortex chamber after being accelerated by an acceleration chamber, and meanwhile, compressed air enters through a vent hole of the vortex chamber, so that the three-phase flow is further rotationally mixed and accelerated and then is sprayed to a grinding region in the form of atomized droplets through an outlet of the spray nozzle.

A precise lubrication pump of a micro-lubrication system designed in the prior art is characterized in that a lubricant enters a liquid chamber from an oil inlet hole and is driven by the compressed air, when the compressed air enters the air chamber, the pressure at a tail part of a piston rod is increased; when the pressure is greater than an elastic force of a piston spring at a front end of the piston rod, the piston rod moves forward, the liquid chamber shrinks and the pressure is increased; when the pressure is greater than the elastic force of a check valve spring, a check valve plug is opened and the lubricant is pumped out; the pressure of the liquid chamber is released; when the pressure is less than the elastic force of the check valve spring, the check valve spring is reset, and an oil outlet is sealed; when the pressure of the air chamber is released, the pressure at the tail part of the piston rod is less than the elastic force of the piston spring, and the piston rod is reset. The precise lubrication pump of the micro-lubrication system has the advantages that a miniature precise pneumatic pump capable of accurately supplying oil is provided, and is precise in design and suitable for various lubricants to be used in lubrication devices for metal processing.

A continuous liquid supply type micro-lubrication device designed in the prior art is characterized in that the device comprises a peristaltic pump, an air source processor, an air-liquid joint, an air source air pipe, an input air pipe, an infusion hose, a liquid outlet hose, an air-liquid coaxial pipe, a spray nozzle and a tank body for mounting the above components; the air source processor is fixedly mounted outside the tank body; an inlet of the peristaltic pump is connected with a container for containing cutting fluid through the infusion hose, and an outlet is connected with a first inlet of the air-liquid joint through the liquid outlet hose; the inlet of the air source processor is connected with the air source air pipe, and the outlet is connected with a second inlet of the air-liquid joint through the input air pipe; the outlet of the air-liquid joint is connected with the spray nozzle through the air-liquid coaxial pipe; and the compressed air and the cutting fluid are mixed in the spray nozzle to form cutting fluid mist and are sprayed out. The continuous liquid supply type micro-lubrication device has the characteristics of compact structure, simple operation, accurate control of oil quantity, continuous supply of the cutting fluid, convenient mounting, etc.

Although the above three micro-lubrication devices replace a traditional pouring mode with a micro-lubrication mode, the connection spray nozzle structures are still traditional universal pipes. Before milling with a milling machine, people may approximately align the spray head with a milling cutter by understanding the milling processing, however, when the milling machine mills a circumference, a deep groove and other abnormal angles, the cutting fluid cannot be sprayed around a working point of the milling cutter, causing waste of the cutting fluid and surface burning of the workpieces; and continuous tracking and spraying of the cutting fluid for machining with the milling machine also cannot be realized.

### SUMMARY OF PRESENT INVENTION

In view of the above problems, the purpose of the patent of the present invention is to provide an intelligent spray head which supports continuous tracking and spraying of cutting fluid under different machining conditions of a CNC milling machine. The transverse rotation of the device is driven by a stepping motor, and the longitudinal angle adjustment and the spray head follow-up adjustment are driven by the compressed air, so as to track abnormal angles of working points of a milling cutter under various machining conditions and intelligently adjust an air-liquid ratio at different temperatures, thereby improving the cooling and lubricating effect of a machining region and the quality of a workpiece machining surface, and providing equipment support for intelligent supply of micro-lubrication.

In order to achieve the above purpose, the following technical solution is adopted in the present invention.

A first purpose of the present invention is to disclose an MDOF (multi-degree-of-freedom) micro-lubrication intelligent spray head system for a CNC milling machine, comprising an annular rotating platform, a longitudinal telescopic part, a rotating part, an intelligent spray head mounting platform and an information acquisition system.

The annular rotating platform comprises a rotating piece which rotates along a horizontal circumferential direction; a bottom of the rotating piece is connected with at least one longitudinal telescopic part; a lower end of the longitudinal telescopic part is connected with the rotating part; the rotating part rotates within a set angle range by taking a point connected with the longitudinal telescopic part as an axis; the intelligent spray head mounting platform is connected with the rotating part and moves along with the rotating part; and the information acquisition system is mounted on the intelligent spray head mounting platform.

Further, the annular rotating platform comprises a rotating platform housing, a rotating body, a stepping motor and a power transmission device.

The stepping motor is arranged inside the rotating platform housing, and is connected with the rotating body through the power transmission device to drive the rotating body to rotate.

Further, the longitudinal telescopic part comprises a telescopic cylinder and an extension piece; the extension piece comprises a fixed end and an extended end; the telescopic cylinder is connected with the annular rotating platform by the fixed end; a telescopic rod of the telescopic cylinder is connected with the extended end; a fixed end is arranged between the extended end and the fixed end of the extension piece; and the telescopic cylinder provides power to realize longitudinal extension of the extended end.

Further, two longitudinal telescopic parts are respectively fixed at both ends of the bottom of the annular rotating platform.

Further, the rotating part comprises a rotating cylinder and a mechanical arm; the rotating cylinder is connected with the longitudinal telescopic parts; the mechanical arm is fixed on a rotating disk of the rotating cylinder, a magnetic sensor is arranged on the rotating cylinder, and a rotating angle of the rotating disk is determined by the magnetic sensor.

Further, a spraying angle of the intelligent spray head is finely adjusted by the rotating cylinder.

Further, the mechanical arm is an L-shaped plastic steel frame.

Further, the L-shaped plastic steel frame is provided with a fixed end at each of an upper end and a lower end; an upper fixed end is a flange plate for connecting a rotating shaft of the rotating cylinder, a lower part of the L-shaped plastic steel frame is a cross rod; and a screw hole for fixing the rotating cylinder is formed in the cross rod.

Further, the intelligent spray head mounting platform is connected with the rotating part and is provided with a platform connected with the telescopic cylinder.

Further, the information acquisition system comprises an infrared sensor, a single chip microcomputer and an information acquisition card; the infrared sensor acquires real-time signals of machining tools of the milling machine; and the information acquisition card transmits the information acquired by the infrared sensor to the single chip microcomputer, thereby optimizing a movement path of the equipment and realizing better tracking and spraying.

### BENEFICIAL EFFECTS OF THE PRESENT INVENTION

The device adopts combined driving of the stepping motor and air pressure. The stepping motor provides a rotating force for the rotating disk; and the air pressure provides power for the telescopic cylinder and the rotating cylinder. The device is provided with the infrared sensor, which can collect machining data in real time; an angle of the spray head is reasonably adjusted through the machining data; an air-liquid ratio is reasonably configured to guarantee that the spray head sprays a machined workpiece at a reasonable angle; the defects that a traditional cutting fluid spray head is fixed and a spraying angle is limited are replaced; and the problems of dead corners on a cut surface and the waste of the cutting fluid are solved.

### DESCRIPTION OF THE DRAWINGS

FIG. 1 is an isometric view of an MDOF micro-lubrication intelligent spray head system for a CNC milling machine;

FIGS. 2(a)-(c) are respectively three views of an MDOF micro-lubrication intelligent spray head system for a CNC milling machine;

FIG. 3 is an exploded diagram of an annular rotating platform;

FIG. 4 is an isometric view of a rotating platform housing;

FIG. 5 is a rotating body upper end cover and a left sectional view thereof;

FIG. 6 is a rotating body lower end and a left sectional view thereof;

FIG. 7 is a sectional view of an annular rotating platform;

FIG. 8 is an arrangement diagram of a synchronous belt;

FIG. 9 is an exploded diagram of an extension part of a longitudinal telescopic system;

FIG. 10 is a structural schematic diagram of a telescopic cylinder;

FIG. 11 is a top view of an extension part of a longitudinal telescopic system;

FIG. 12 is a sectional view I of an extension part of a longitudinal telescopic system;

FIG. 13 is a sectional view II of an extension part of a longitudinal telescopic system;

FIG. 14 is an exploded diagram of a rotating arm fixing end;

FIG. 15 is a front structural diagram of a rotating cylinder;

FIG. 16 is a side structural diagram of a rotating cylinder;

FIGS. 17(a)-(c) are three views of a rotating cylinder;

FIGS. 18(a)-(c) are three views of a rotating arm;

FIG. 19 is a sectional view of a rotating arm fixing end assembly;

FIG. 20 is an isometric view of a rotating arm fixing end;

FIGS. 21(a)-(c) are three views of an intelligent spray head mounting platform;

FIG. 22 is an exploded diagram of an intelligent spray head mounting platform;

FIG. 23 is a sectional view of a rotating part assembly of an intelligent spray head mounting platform;

FIG. 24 is an exploded diagram of an intelligent spray head fixing end;

FIGS. 25(a)-(c) are three views of an intelligent spray head fixing end;

FIG. 26 is an infrared sensor information acquisition model; and

FIG. 27 shows parameters D-H of an intelligent spray head.

In the above figures, the reference numerals are as follows:

Annular rotating platform I, longitudinal telescopic arm II, rotating arm III, intelligent spray head mounting platform IV, information acquisition system V, rotating body upper end cover I 1-1, rotating body lower end I 1-2, synchronous wheel I 1-3, synchronous wheel fixing bolt I 1-4, thrust ball bearing I 1-5, nut I 1-6, gasket I 1-7, rotating body connecting bolt I 1-8, rotating body connecting through hole I 1-9, synchronous wheel mounting screw hole I 1-10, counterbore I 1-11, synchronous belt I 1-12, tensioning wheel i 1-13, telescopic cylinder mounting seat I 1-14, through hole I 1-15; rotating platform housing I 2-1, bolt I 2-2, screw hole I 2-3, through hole I 2-4, stepping motor I 3-1, flat key I 2-2 and synchronous wheel I 3-3;

telescopic cylinder II 1, telescopic cylinder body II 1-1, telescopic cylinder piston II 1-2, hexagon flange nut II 1-3, compressed air joint II 1-4, stud II 1-5, gasket II 1-6, nut II 1-7, 90-degree corner II 1-8, bolt II 1-9, telescopic cylinder front end cover I 1-10, telescopic cylinder rear end cover II 1-11, sealing ring II 1-12, magnetic ring II 1-13, sealing ring II 1-14, telescopic cylinder A air hole II 1-15, telescopic cylinder B air hole II 1-16, through hole II 1-17, sealing ring II 1-18, sealing ring II 1-19, magnetic sensor II 2-1, flat head screw II 2-2, through hole II 2-3, telescopic slide block base II 3-1, telescopic slide block II 3-2, gasket II 3-3, nut II 3-4, bolt II 3-5, fixed end II 3-6, screw hole II 3-7 and through hole II 3-8;

rotating cylinder III 1, sealing ring III 1-1, buffer III 1-2, sealing ring III 1-3, magnetic ring III 1-4, small rack III 1-5, gear III 1-6, counterbore III 1-7, rotating cylinder A air hole II 1-8, rotating shaft m 1-9, deep groove ball bearing III 1-10, sealing ring III 1-11, rotating cylinder lower end cover III 1-12, sealing ring III 1-13, deep groove ball bearing III 1-14, rotating cylinder upper end cover III 1-15, hexagon socket head bolt II 1-16, hexagon socket head bolt III 1-17, rotating disk II 1-18, hexagon socket head bolt III 1-19, flat key III 1-20, hexagon socket head bolt III 1-21, rotating cylinder rear end cover III 1-22, rotating cylinder front end cover II 1-23, rotating cylinder B air hole III 1-24, magnetic sensor III 2, screw III 2-1, counterbore III 2-2, screw hole III 2-3, hexagon socket head bolt III 2-4, L-shaped plastic steel frame III 2-5, counterbore III 2-6, hexagon socket head bolt III 2-7, magnetic sensor IV 1, flat head screw IV 1-1, counterbore IIV 1-2 and magnetic sensor holder IV 1-3;

rotating cylinder IV 2, external clamping groove IV 2-1, hexagon socket head bolt IV 2-2, screw hole IV 2-3, hexagon socket head bolt IV 2-4, through hole IV 2-5, spray head fixing platform housing IV 3, bolt IV 3-1, through hole IV 3-2, screw hole IV 3-3, end cover IV 3-4, telescopic cylinder mounting platform IV 3-5 and through hole IV 3-6;

two-way spray head V 1, screw hole V 1-1, first joint V 1-2, second joint V 1-3, fixing ring V 1-4, bolt V 1-5, gasket V 1-6, nut V 1-7, screw hole V 1-8, screw hole V 1-9, through hole V 1-10, infrared sensor V 2 and sensor fixing bolt V 2-1.

### DETAILED DESCRIPTION OF PREFERRED EMBODIMENTS

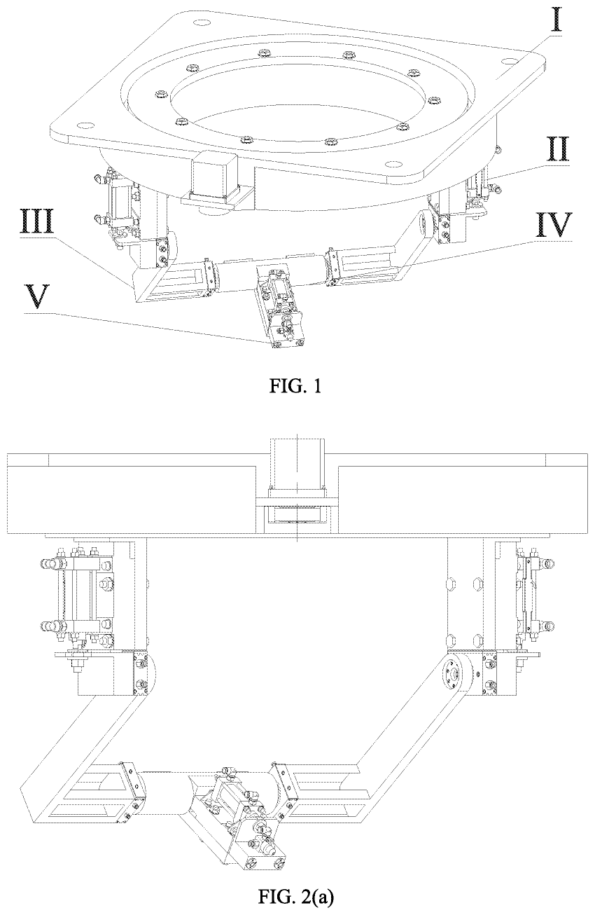

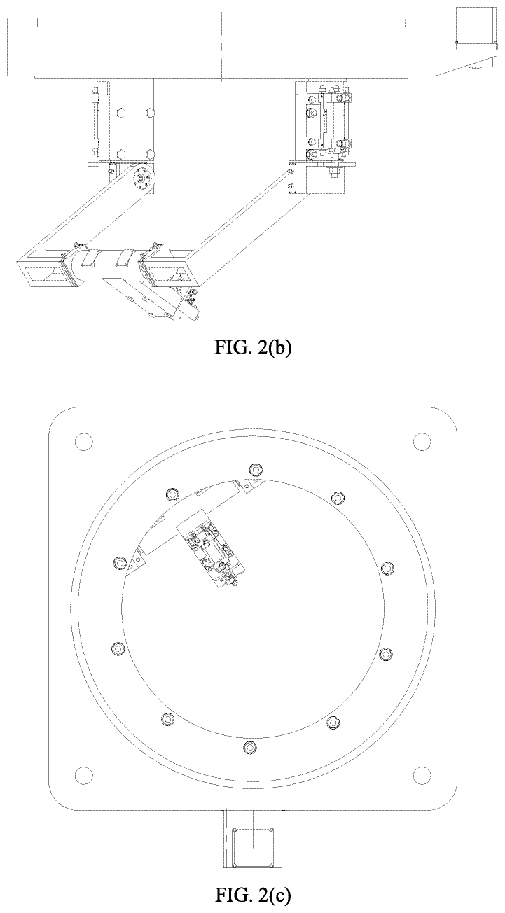

FIG. 1 is an isometric view of an MDOF micro-lubrication intelligent spray head system for a CNC milling machine. FIG. 2 shows three views of the MDOF micro-lubrication intelligent spray head system for the CNC milling machine. FIG. 2(a) is a front view, FIG. 2(b) is a left view, and FIG. 2(c) is a top view.

As shown in FIG. 1 and FIGS. 2(a)-(c), the MDOF micro-lubrication intelligent spray head system provided by the present invention comprises the following five parts: an annular rotating platform I, a longitudinal telescopic arm II, a rotating arm III, a spray head mounting platform IV and an information acquisition system V.

The annular rotating platform comprises a rotating piece which rotates along a horizontal circumferential direction. A bottom of the rotating piece is connected with at least one longitudinal telescopic arm; a lower end of the longitudinal telescopic arm is connected with the rotating arm; the rotating arm rotates within a set angle range by taking a point connected with the longitudinal telescopic arm as an axis; the intelligent spray head mounting platform is connected with the rotating arm and moves along with the rotating arm; and the information acquisition system is mounted on the intelligent spray head mounting platform.

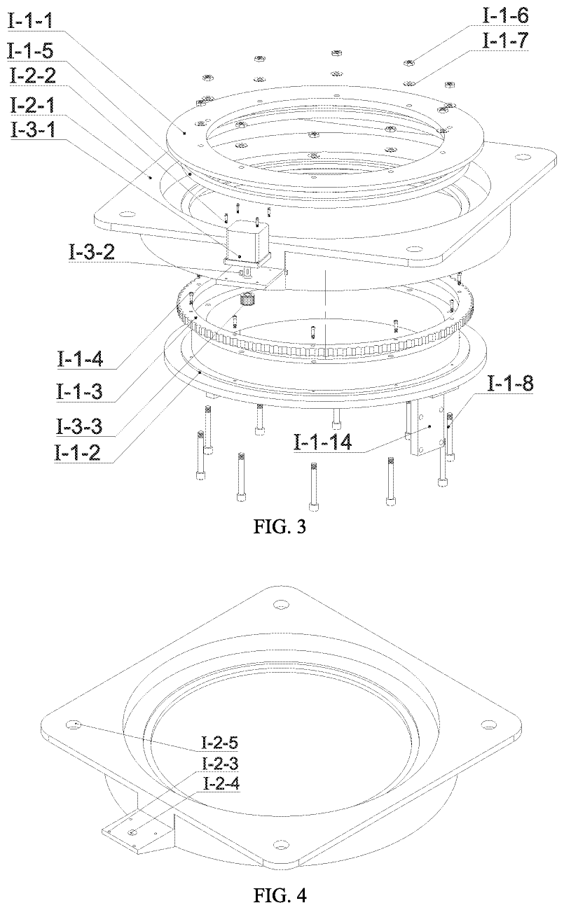

FIG. 3 is an exploded diagram of the annular rotating platform. As shown in the figure, the annular rotating platform comprises a rotating body upper end cover I 1-1, a rotating body lower end I 1-2, synchronous wheels I 1-3, synchronous wheel fixing bolts I 1-4, a thrust ball bearing I 1-5, nuts I 1-6, gaskets I 1-7, rotating body connecting bolts I 1-8, telescopic cylinder mounting seats I 1-14, a rotating platform housing I 2-1, bolts I 2-2, a stepping motor I 3-1, a flat key I 3-2 and a tensioning synchronous wheel I 3-3.

The rotating platform housing I 2-1 is fixed on a bottom surface of a feeding box of the CNC milling machine by bolts. A rotating body is arranged in the rotating platform housing I 2-1; the rotating body is composed of the upper end cover I 1-1 and the rotating body lower end I 1-2; the thrust ball bearing I 1-5 is arranged between the rotating platform housing I 2-1 and the rotating body; the rotation of the rotating body is realized by the thrust ball bearing I 1-5; the synchronous wheels I 1-3 are fixed on the rotating piece through the bolts; tensioning wheels are mounted inside the annular rotating platform; a synchronous belt is arranged inside a gap of the annular rotating platform by the tensioning wheels; and the stepping motor provides power for a rotating platform inside the annular rotating platform to rotate the rotating platform. Two telescopic cylinder mounting seats I 1-14 are arranged at a lower part of the rotating body and are respectively used for fixing the longitudinal telescopic arm, so as to realize point tracking of a working point of a milling cutter when the intelligent spray head is used for milling the circumference of the CNC milling machine.

The rotating body upper end cover I 1-1 and the rotating body lower end I 1-2 are connected to form the rotating body through the rotating body connecting bolts I 1-8, the nuts I 1-6 and the gaskets I 1-7. Screw holes for mounting the synchronous wheels are formed in the rotating body; and the synchronous wheels are fixed on the rotating body by the synchronous belt fixing bolts I 1-4. The rotating platform housing I 2-1 is provided with screw holes; and the stepping motor I 3-1 is fixed on the rotating platform housing I 2-1 by the bolts I 2-2. Square through holes are formed in the rotating platform housing I 2-1; and the synchronous belt I 1-12 passes through the rotating platform housing through the through holes and is mounted on the synchronous wheels I 1-13. A shaft shoulder is arranged between the rotating body and the rotating platform housing I 2-1; and the thrust ball bearing I 1-5 is fixed between the rotating body and the rotating housing I 2-1 by the shaft shoulder to realize the rotation of the rotating body. The power for rotating the rotating body is provided by the stepping motor I 3-1, and is transmitted from the tensioning synchronous wheels I 3-3 to the synchronous wheels I 1-13 by the synchronous belt I 1-12.

FIG. 4 is an isometric view of the rotating body housing. The rotating body housing is a porous component comprising screw holes I 2-3 and through holes I 2-4, wherein the screw holes I 2-3 are used for fixing the stepping motor I 3-1; the through holes I 2-4 are used for fixing the rotating platform housing I 2-1; and the rotating platform housing I 2-1 is fixed on a milling cutter clamp fixing plane of the CNC milling machine.

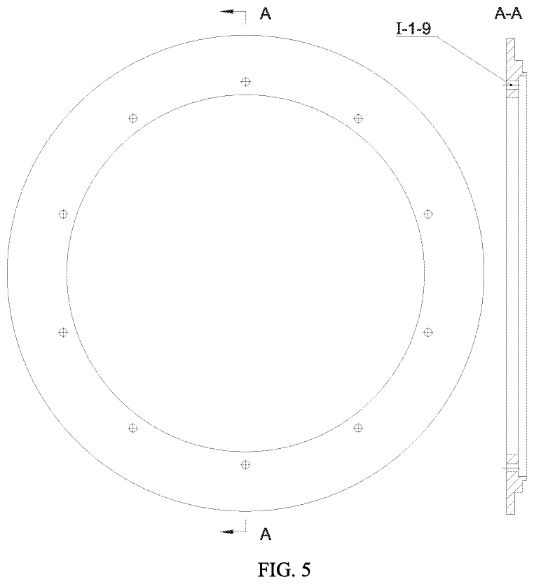

FIG. 5 is the rotating body upper end cover and a left sectional view thereof. As shown in the figure, the rotating body upper end cover is a porous component. The rotating body connecting through holes I 1-9 for connecting the rotating body lower end are formed on the rotating body upper end cover to form the rotating body.

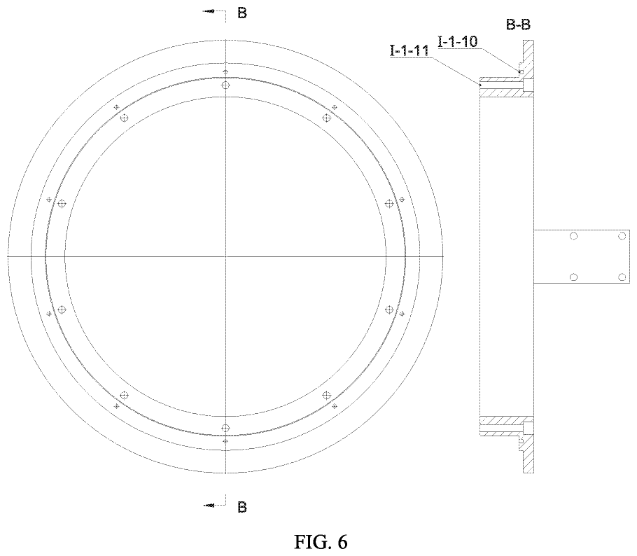

FIG. 6 is the rotating body lower end and a left sectional view thereof. The rotating body lower end is a porous component comprising the synchronous wheel mounting screw holes I 1-10 and counterbores I 1-11, wherein the synchronous wheel mounting screw holes I 1-10 are used for fixing the synchronous belt I 1-12; and the counterbores I 1-11 are used for connecting the rotating body upper end cover I 1-1 with the rotating body lower end I 1-2 to form the rotating body and realize the rotation tracking of the spray head in an XY plane.

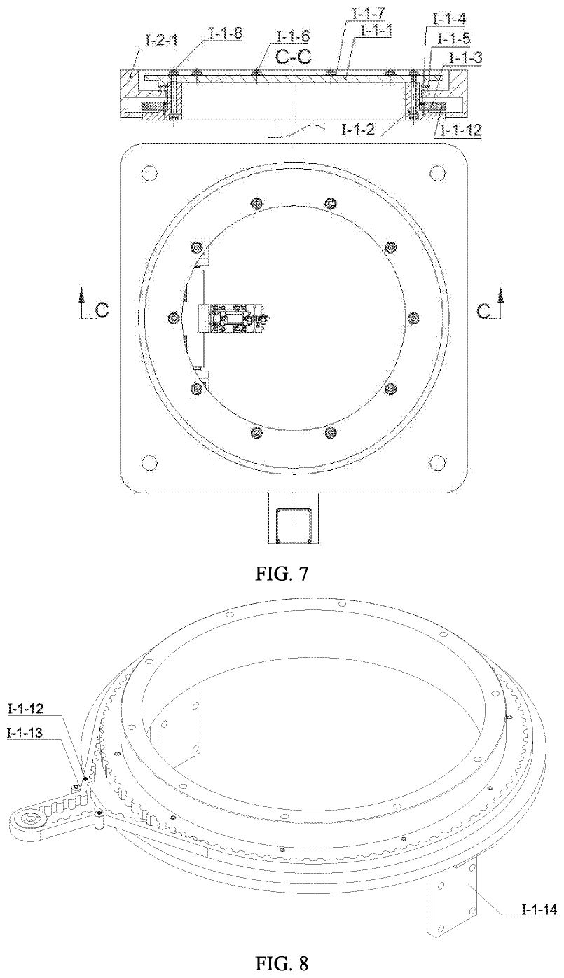

FIG. 7 is a sectional view of an annular rotating platform assembly. As shown in the figure, the annular rotating platform is composed of two parts: a rotating body housing I 2-1 and the rotating body. The thrust ball bearing I 1-5 is arranged between the two parts; the rotating body housing is fixed on a machine tool by the bolts, so as to realize the immobilization of the rotating body housing and the rotary motion of the rotating body. The rotational power is provided by the stepping motor I 3-1 and is transmitted by the synchronous belt I 1-12.

FIG. 8 is an arrangement diagram of a synchronous belt. As shown in the figure, the synchronous belt is mounted on two synchronous wheels, and the synchronous belt is tensioned by two tensioning wheels to ensure transmission accuracy of the synchronous belt. The rotating body lower end is further provided with telescopic cylinder mounting seats I 1-14 for fixing the telescopic cylinder.

The longitudinal telescopic system is composed of a telescopic cylinder II 1, a magnetic sensor II 2-1, an extension arm, a compressed air joint II 1-4, bolts, etc.

The extension arm comprises two parts: an extended end II 3-2 and a fixed end II 3-6. A through hole II 3-5 and a screw hole II 3-7 are formed in the fixed end; the through hole II 3-5 is used for connecting the fixed end of the rotating body lower end; and the screw hole II 3-7 is used for fixing the telescopic cylinder. A mounting plate is arranged at a front end of the extended end. A screw hole II 3-9 for fixing the rotating cylinder m 1 is formed on the mounting plate. A fixed end is arranged between the extended end II 3-2 and the fixed end II 3-6 of the extension arm; and the telescopic cylinder II 1 provides power to realize longitudinal lifting of the intelligent spray head.

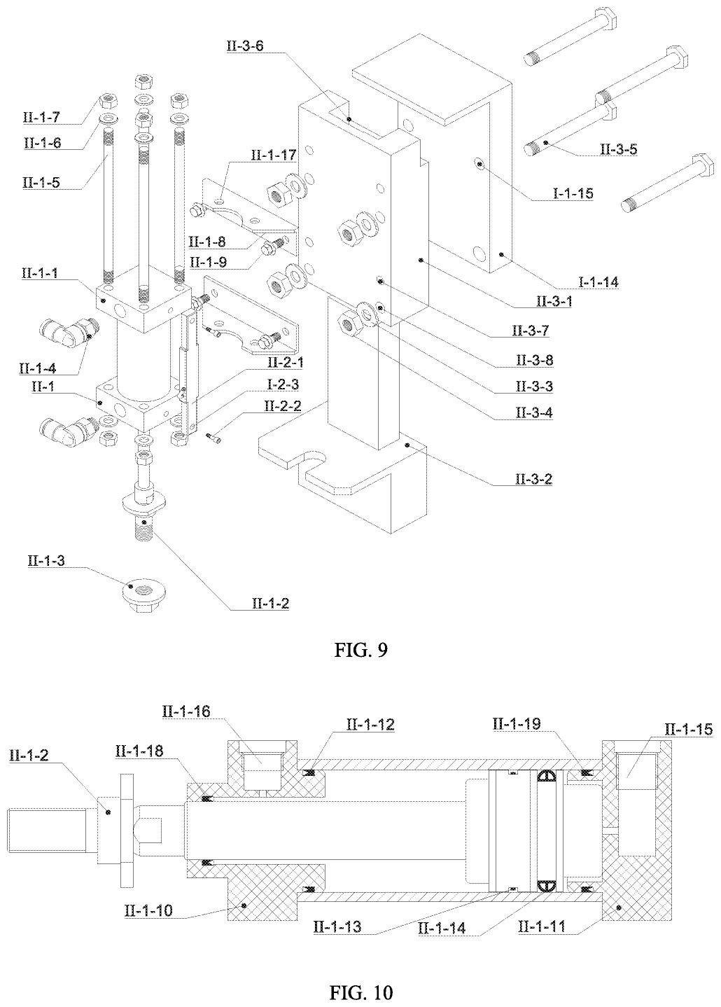

FIG. 9 is an exploded diagram of an extension part of the longitudinal telescopic system. As shown in the figure, the extension part of the longitudinal telescopic system comprises a telescopic cylinder body II 1, a contraction cylinder body II 1-1, a telescopic cylinder piston II 1-2, hexagon flange nuts II 1-3, compressed air joints II 1-4, studs II 1-5, gaskets II 1-6, nuts II 1-7, 90-degree corners II 1-8, bolts II 1-9, through holes II 1-17, telescopic cylinder mounting seats I 1-14, through holes I 1-15, magnetic sensors II 2-1, flat head screws II 2-2, through holes II 2-3, telescopic slide block base II 3-1, telescopic slide block II 3-2, gaskets II 3-3, nuts II 3-4, bolts II 3-5, a fixed end II 3-6, screw holes II 3-7 and through holes II 3-8. The telescopic slide block base is fixed on the telescopic cylinder mounting seats I 1-14 by the bolts II 3-5; and the telescopic cylinder is fixed on the telescopic slide block base II 3-1 by the 90-degree corners II 1-8 and the bolts II 1-9. The telescopic slide block II 3-2 is provided with a bayonet; a cylindrical structure is arranged at a front end of the telescopic cylinder piston and can be clamped on the bayonet; and the front end of the piston is fixed at the bayonet by the hexagon flange nuts II 1-3 so that the telescopic movement of the slide block is realized through reciprocating movement of the piston. The magnetic sensors II 2-1 are fixed on one side of the telescopic cylinder by the flat head screws II 2-2, and are used for collecting the position of the piston in the telescopic cylinder and performing closed-loop control. An air pipe joint can be mounted at each of a front end and a rear end of the telescopic cylinder to provide power for the movement of the telescopic slide block.

FIG. 10 is a structural schematic diagram of the telescopic cylinder. As shown in the figure, the telescopic cylinder comprises the telescopic cylinder piston II 1-2, a telescopic cylinder front end cover II 1-10, a telescopic cylinder rear end cover II 1-11, a sealing ring II 1-12, a magnetic ring II 1-13, a sealing ring II 1-14, a telescopic cylinder A air hole II 1-15, a telescopic cylinder B air hole II 1-16, a sealing ring II 1-18 and a sealing ring II 1-19. The compressed air enters from port B so that the cylinder piston moves towards the A air hole to realize the extension of the moving slide block; and the compressed air enters from port A so that the cylinder piston moves towards the B air hole to realize the shortening of the moving slide block. The telescopic cylinder front end cover II 1-10 and the telescopic cylinder rear end cover II 1-11 block a cylinder body from both sides; and the two end covers are each provided with four through holes and are tightly jointed together by four studs. The whole mechanism realizes the sealing of an internal environment of the telescopic cylinder by four sealing rings; and the magnetic ring is sleeved on the piston to provide a position signal for the magnetic sensors.

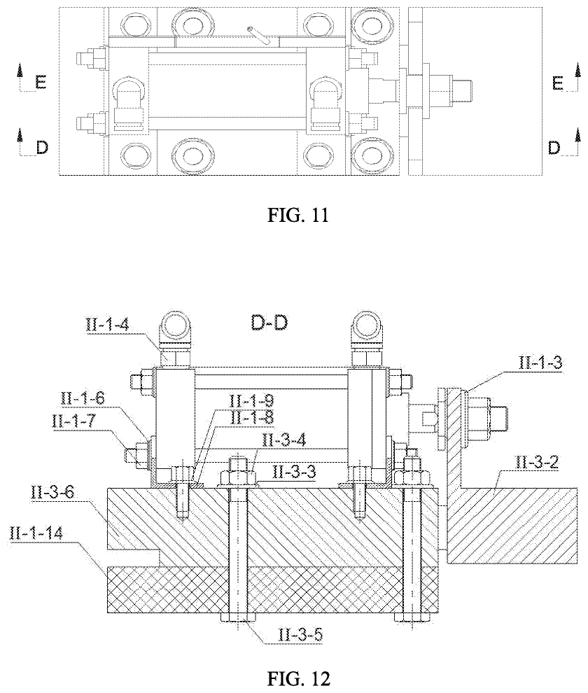

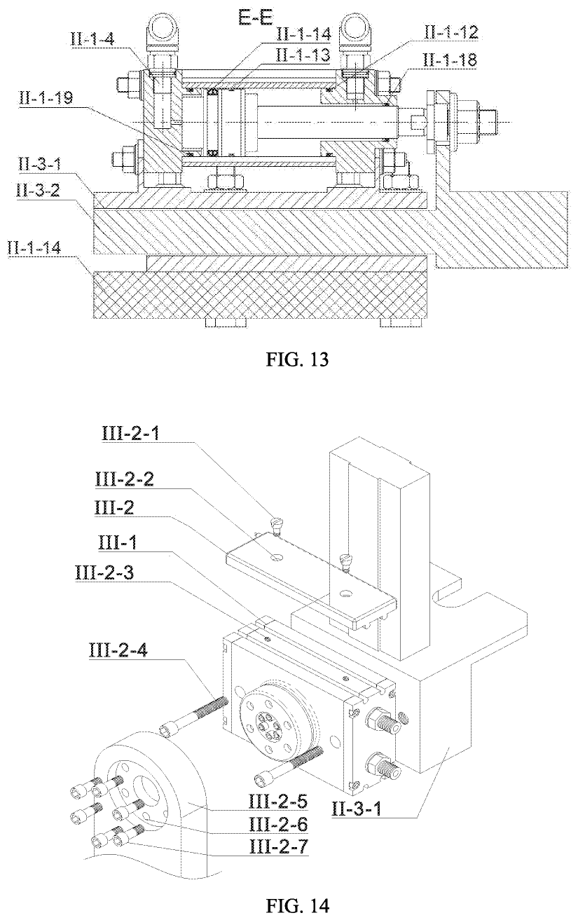

FIG. 11 is a top view of the extension part of the longitudinal telescopic system. FIG. 12 is a sectional view I of the extension part of the longitudinal telescopic system. FIG. 13 is a sectional view II of the extension part of the longitudinal telescopic system. As shown in the figures, assembling conditions of the longitudinal telescopic system are as follows: the telescopic slide block base is fixed on the telescopic cylinder mounting seats I 1-14 by the bolts II 1-9; and the telescopic cylinder is fixed on the telescopic slide block base A II 3-1 by the 90-degree corners II 1-8 and the bolts II 3-5. The telescopic sliding block II 3-2 is provided with a bayonet; the front end of the telescopic cylinder piston is provided with the cylindrical structure which can be clamped on the bayonet; and the front end of the piston is fixed at the bayonet by the hexagon flange nuts II 1-3 so that the telescopic movement of the slide block is realized through the reciprocating movement of the piston.

The rotating arm comprises two parts: a rotating cylinder and a mechanical arm, wherein the mechanical arm is a hollow L-shaped plastic steel frame; the bottom surface of the rotating cylinder is fixed at a lower fixing end of the extension arm of the longitudinal telescopic system; a rotating disk of the rotating cylinder is provided with a flange structure; and the mechanical arm is fixed on the rotating disk of the rotating cylinder by the bolts.

The L-shaped plastic steel frame is provided with a fixed end at each of an upper end and a lower end. The upper fixed end is a flange plate and is connected with a rotating shaft of the rotating cylinder by the bolts. A lower part of the L-shaped plastic steel frame is a flat end; and the flat end is provided with the screw hole for fixing the rotating cylinder which is connected by the bolts.

FIG. 14 is an exploded diagram of the rotating arm fixing end. As shown in the figure, the rotating arm comprises a rotating cylinder III 1, a magnetic sensor III 2, screws II 2-1, counterbores III 2-2, screw holes III 2-3, hexagon socket head bolts III 2-4, an L-shaped plastic steel frame II 2-5, counterbores III 2-6, hexagon socket head bolts III 2-7, a telescopic slide block II 3-1 and screw holes II 3-9. The rotating cylinder III 1 as a main executing piece of the rotating arm system is used for providing a rotating force for the intelligent spray head mounting platform and is fixed on the telescopic slide block II 3-1 by the hexagon socket head bolts 112-4. The L-shaped plastic steel frame III 2-5 is fixed on a rotating chuck of the rotating cylinder III 1 by the hexagon socket head bolts III 2-7; and the rotation of the L-shaped plastic steel frame III 2-5 is driven by the rotation of the rotating chuck.

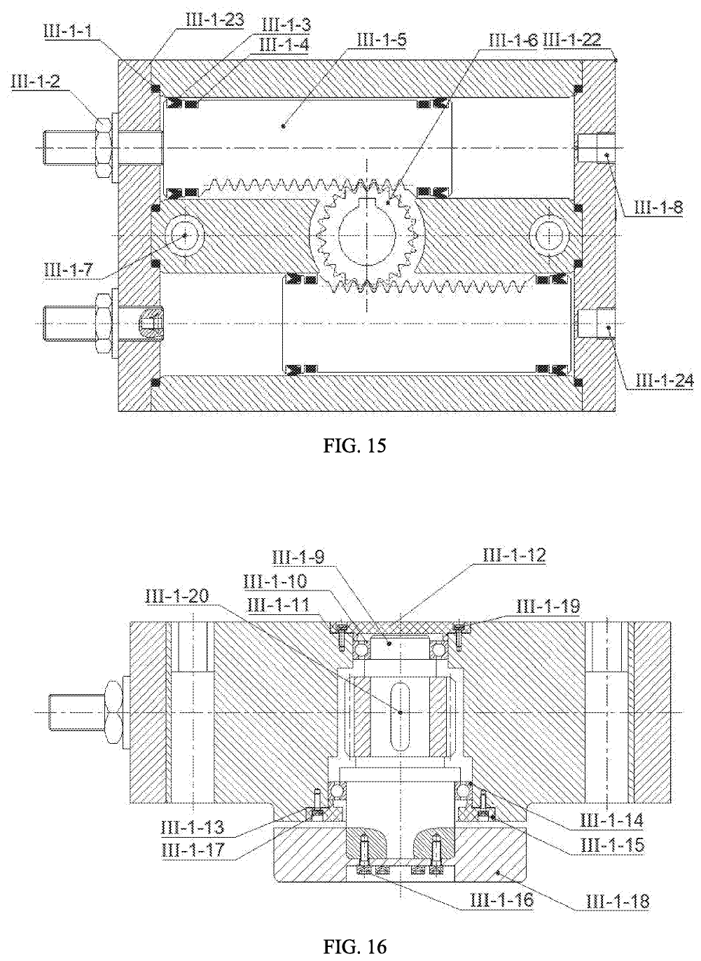

FIG. 15 is a front structural diagram of the rotating cylinder. As shown in the figure, the rotating cylinder comprises sealing rings III 1-1, buffers III 1-2, sealing rings III 1-3, magnetic rings III 1-4, small racks II 1-5, a gear III 1-6, counterbores III 1-7, rotating cylinder A air holes III 1-8, a rotating cylinder rear end cover III 1-22, a rotating cylinder front end cover II 1-23 and rotating cylinder B air holes m 1-24. The rotating cylinder is provided with two air holes. The compressed air is introduced from the A air holes, so that the rack A is moved forward; and meanwhile, the rotating shaft is driven to rotate counterclockwise by the gear, so that the rack B is moved backward. When the compressed air is introduced from the B air holes, the rack B is moved forward; and meanwhile, the rotating shaft is driven to rotate counterclockwise by the gear so that the rack A is moved backward. In this way, the rotating disk of the rotating cylinder is driven to rotate clockwise and counterclockwise. The magnetic ring is arranged on the rack A; and the magnetic ring also moves when the rack A moves. The magnetic sensor determines the position of the rack A by collecting magnetic signals of the magnetic ring, thereby determining a rotation angle of the rotating disk.

FIG. 16 is a side structural diagram of the rotating cylinder. As shown in the figure, the rotating cylinder comprises a rotating shaft III 1-9, deep groove ball bearings III 1-10, sealing rings III 1-11, a rotating cylinder lower end cover III 1-12, sealing rings III 1-13, deep groove ball bearings III 1-14, a rotating cylinder upper end cover II 1-15, hexagon socket head bolts III 1-16, hexagon socket head bolts III 1-17, a gear III 1-6, a rotating disk III 1-18, hexagon socket head bolts III 1-19 and a flat key III 1-20. The gear III 1-6 is connected to the rotating shaft III 1-9 by the flat key III 1-20; the rotating shaft III 1-9 is mounted inside the rotating cylinder III 1-9 from an upper port of the rotating cylinder III 1-9; and the rotating shaft is provided with a shaft shoulder, the rotating cylinder lower end cover III 1-12 and the rotating cylinder upper end cover III 1-15 and can position the deep groove ball bearings III 1-10 and the deep groove ball bearings III 1-14. The rotating cylinder lower end cover III 1-12 is fixed by the hexagon socket head bolts III 1-19; and the rotating cylinder upper end cover III 1-15 is fixed by the hexagon socket head bolts III 1-17. A group of counterbores III 1-7 are arranged on a center line of the rotating cylinder and are used for fixing the rotating cylinder on a telescopic slide block A.

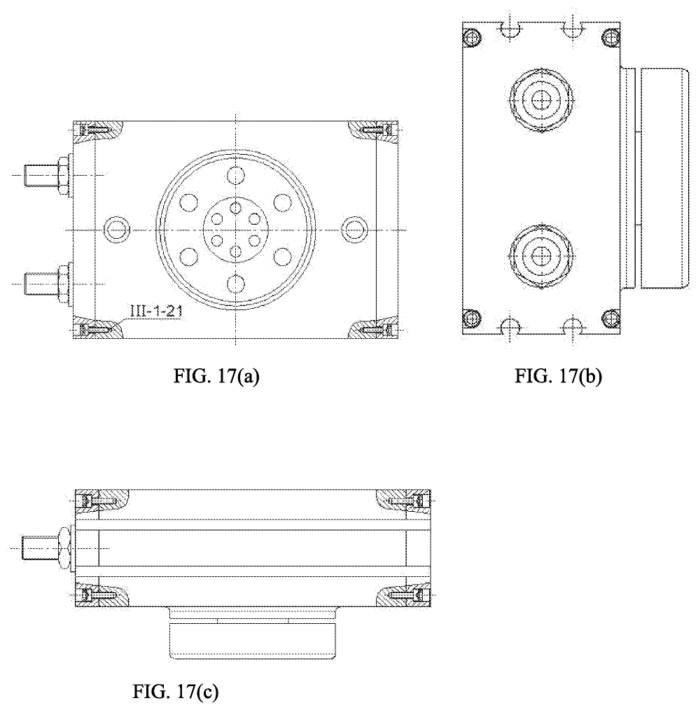

FIG. 17 shows three views of the rotating cylinder. As shown in the figure, four counterbores are formed in each of the rotating cylinder front end cover III 1-23 and the rotating cylinder rear end cover III 1-22; and the rotating cylinder front end cover III 1-23 and the rotating cylinder rear end cover III 1-22 can be fixed to the rotating cylinder body by hexagon socket head bolts m 1-21.

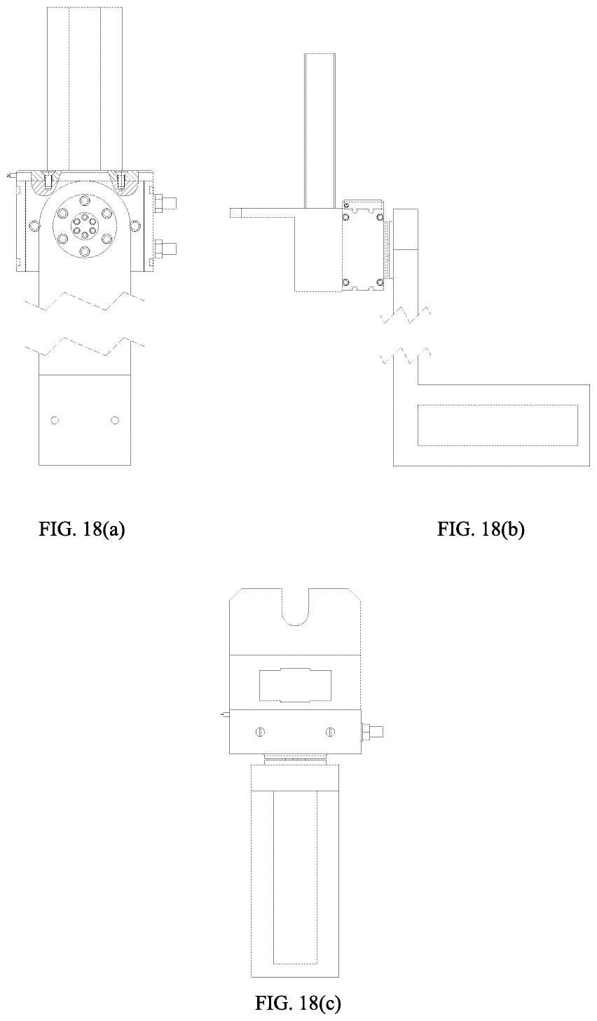

FIG. 18 shows three views of the rotating arm system. FIG. 18(a) is a front view of the rotating arm system. FIG. 18(b) is a left view of the rotating arm system. FIG. 18(c) is a top view of the rotating arm system.

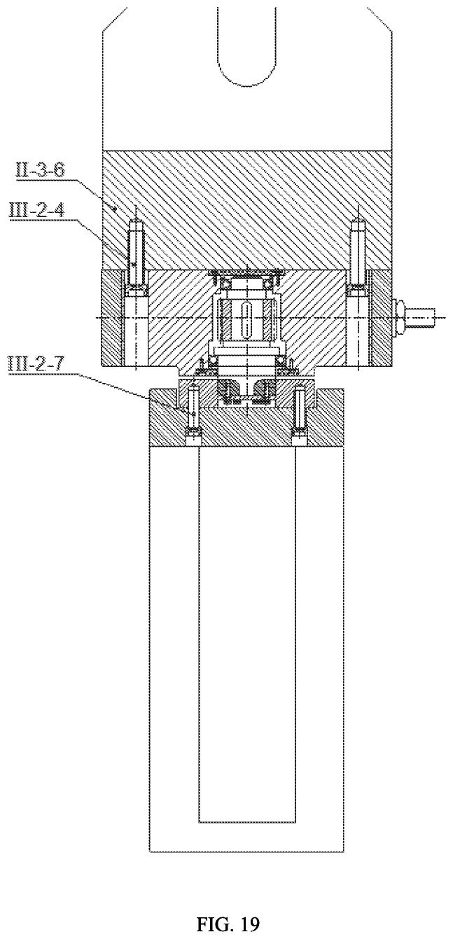

FIG. 19 is a sectional view of a rotating arm fixing end assembly. An L-shaped plastic steel frame III 2-5 is connected with the rotating cylinder by hexagon socket head screws III 2-7; and the rotating cylinder is fixed on an extension arm fixed end II 3-6 by hexagon socket head screws III 2-4.

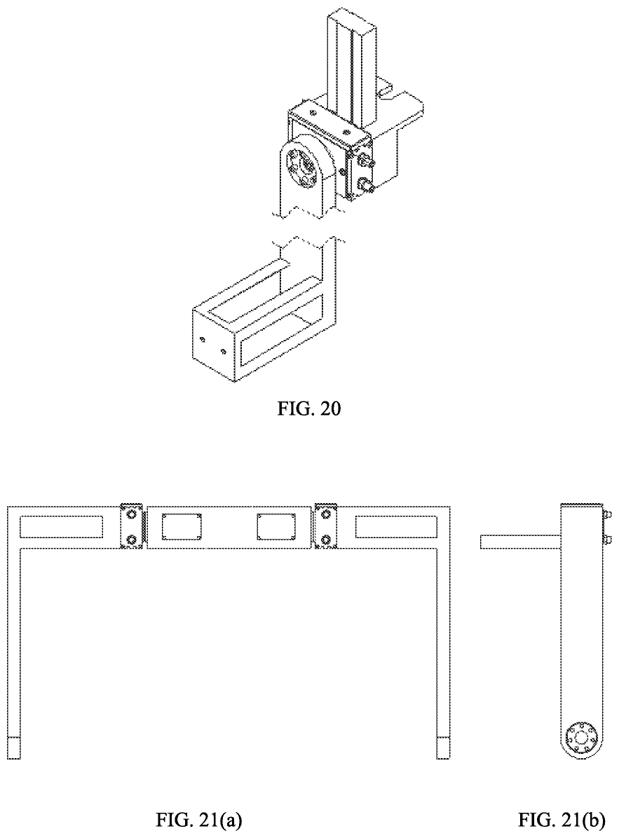

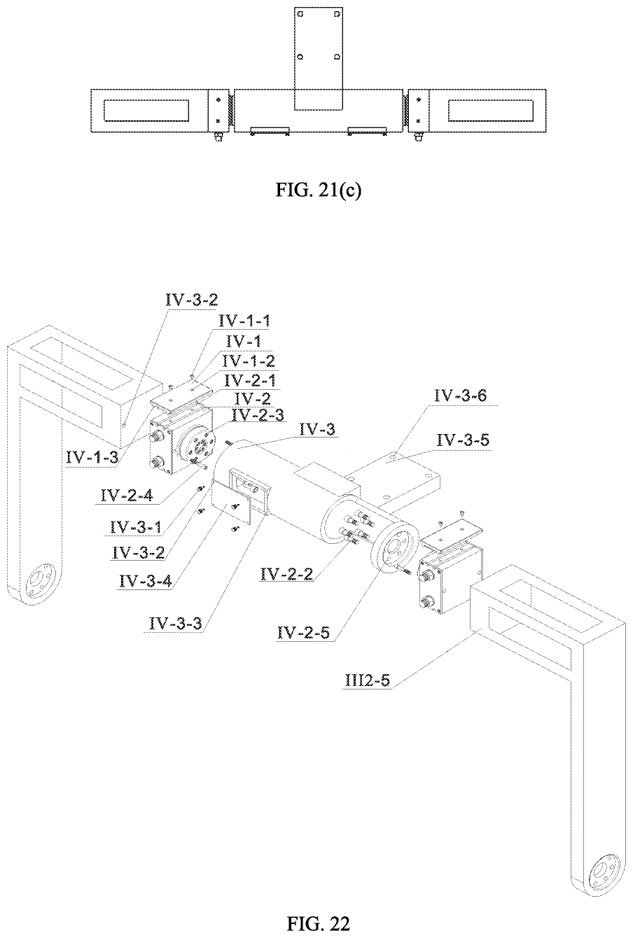

FIG. 20 is an isometric view of the rotating arm fixing end. FIG. 21 shows three views of a spray nozzle mounting platform. FIG. 21(a) is a front view of the spray nozzle mounting platform. FIG. 21(b) is a left view of the spray nozzle mounting platform. FIG. 21(c) is a top view of the spray nozzle mounting platform.

FIG. 22 is an exploded diagram of the spray nozzle mounting platform. As shown in the figure, the spray nozzle mounting platform comprises magnetic sensors IV 1, flat head screws IV 1-1, counterbores IV 1-2, magnetic sensor holders IV 1-3, rotating cylinders IV 2, external clamping grooves IV 2-1, hexagon socket head bolts IV 2-2, screw holes IV 2-3, hexagon socket head bolts IV 2-4, through holes IV 2-5, a spray head fixing platform housing IV 3, bolts IV 3-1, through holes IV 3-2, screw holes IV 3-3, an end cover IV 3-4, a telescopic cylinder mounting platform IV 3-5, through holes IV 3-6 and L-shaped plastic steel frames III 2-5. Two flange plates are arranged at both ends of the spray head fixing platform housing, and the rotating cylinders connect the rotating disks with the flange plates by the bolts. The two counterbores are uniformly distributed on an axis of each rotating cylinder, and the rotating cylinders are fixed on the flat ends of the L-shaped plastic steel frames III 2-5 by the bolts. Two square mounting holes are formed in the spray nozzle fixing platform housing; and the rotating plates can be connected with the flange plates through the mounting holes.

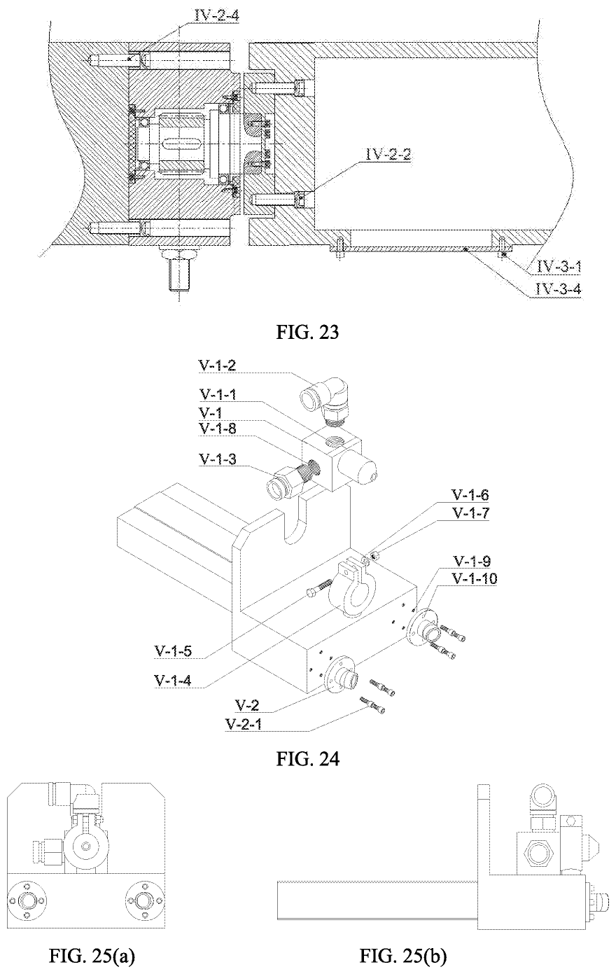

FIG. 23 is a sectional view of a rotating part assembly of the intelligent spray head mounting platform. The rotating cylinder fixing platform housing IV 3 is connected with the rotating cylinders by the hexagon socket head bolts IV 2-2; and the rotating cylinders are fixed on the L-shaped plastic steel frames III 2-5 by the hexagon socket head bolts IV 2-4.

FIG. 24 is an exploded diagram of the spray nozzle fixing end. As shown in the figure, the spray nozzle fixing end comprises a two-way spray head V 1, a screw hole V 1-1, a first joint V 1-2, a second joint V 1-3, a fixing ring V 1-4, a bolt V 1-5, a gasket V 1-6, a nut V 1-7, a screw hole V 1-8, screw holes V 1-9, through holes V 1-10, infrared sensors V 2 and hexagon socket head bolts V 2-1.

FIG. 25 shows three views of the spray nozzle fixing end. FIG. 25(a) is a front view of the spray nozzle fixing end. FIG. 25(b) is a left view of the spray nozzle fixing end. FIG. 25(c) is a top view of the spray nozzle fixing end.

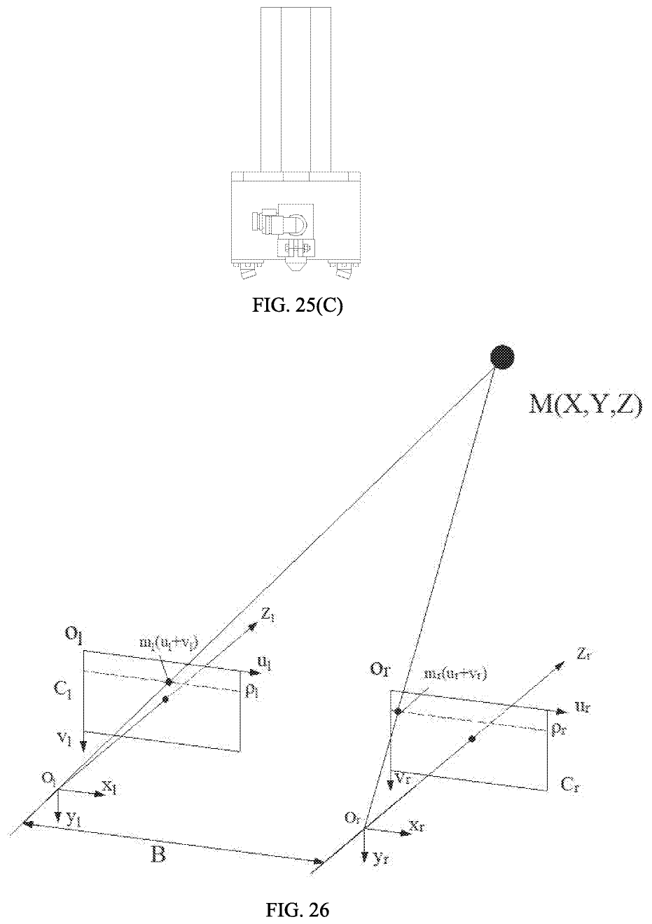

FIG. 26 is an infrared sensor information acquisition model. As shown in the figure, optical axes of a left infrared sensor and a right infrared sensor are mounted on the same straight line; and imaging planes of cameras of the two infrared sensors are coplanar. A distance between the two sensors in the figure is B, called a baseline distance. A machining point of a milling cutter and a workpiece is set as M (X, Y, Z), which is imaged as a point ml (u₁, v₁) and a point mᵣ (uᵣ, vᵣ) in a left camera C₁ and a right camera Cᵣ; and it is assumed that the point M is in a coordinate system (X_{c}, Y_{c}, Z_{c}) of the left camera, a focal distance between the left camera and the right camera is f, and parameters comprise σx, σy, u₀ and v₀. According to a principle of similar triangles, the following equation can be obtained:

$$\{ \begin{matrix}{μ}_{1} - {μ}_{0} = f ( \frac{X}{{Z}_{c}} ) \\ {μ}_{r} - {μ}_{0} = f ( \frac{{X}_{c} - B}{{Z}_{c}} ) \\ {v}_{1} - {v}_{0} = {v}_{r} - {v}_{0} = f ( \frac{{Y}_{c}}{{Z}_{c}} )\end{matrix} . \qquad ( 1 )$$

Thus, coordinates of the point M in the coordinate system of the left camera are

$$\{ \begin{matrix}{X}_{c} = B \frac{{μ}_{1} - {μ}_{0}}{{μ}_{1} - {μ}_{r}} \\ {Y}_{c} = B \frac{{v}_{1} - {v}_{0}}{{μ}_{1} - {μ}_{r}} \\ {Z}_{c} = \frac{Bf}{{μ}_{1} - {μ}_{r}}\end{matrix} . \qquad ( 2 )$$

The equation 2 shows that depth information of the point M is inversely proportional to a parallax d=μ₁−μᵣ of the cameras. It can be seen from here that when a shooting distance is increased, the parallax is reduced and the public view is broadened. When the shooting distance is reduced or even is very small, the left camera and the right camera almost have no public view.

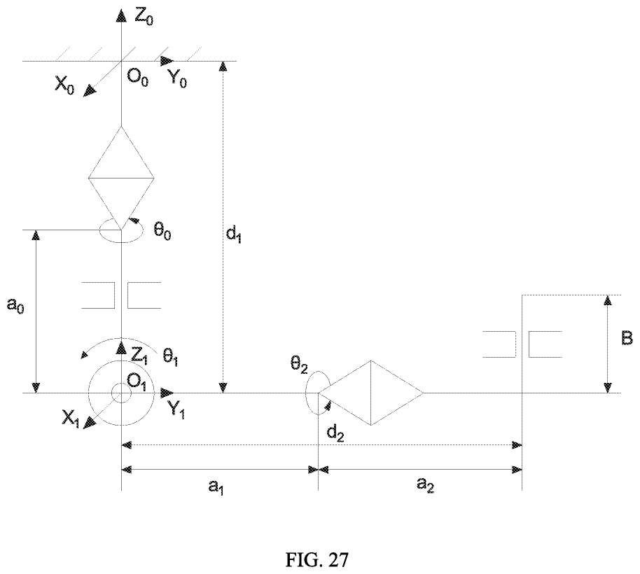

FIG. 27 shows parameters D-H of the intelligent spray head. Coordinate transformation from the coordinate system {Qᵢ₋₁} to the coordinate system {Qᵢ} can be realized through the following transformation sequence of the coordinate system {Qᵢ₋₁}:

(1) rotating an angle θᵢ about an axis zᵢ₋₁ so that the axis xᵢ₋₁ and an axis xᵢ, are in the same direction;

(2) translating a distance dᵢ about an axis zᵢ₋₁ so that the axis xᵢ₋₁ and the axis xᵢ are on the same straight line;

(3) translating a distance aᵢ about the axis xᵢ so that a coordinate origin of the coordinate system {Qᵢ₋₁} coincides with the coordinate origin of the coordinate system {Qᵢ}; and

(4) rotating an angle αᵢ about the axis xᵢ so that the axis zᵢ₋₁ and an axis zᵢ are on the same straight line.

The above transformation is performed with respect to a moving coordinate system every time, so a homogeneous transformation matrix after four transformations is

Tᵢ=Rot(z,θᵢ)Trans(0,0,dᵢ)Trans(aᵢ,0,0)Rot(x,aᵢ),

namely,

$$\begin{matrix}{T}_{i} = [ \begin{matrix}cos {θ}_{i} & - sin {θ}_{i} & 0 & 0 \\ sin {θ}_{i} & cos {θ}_{i} & 0 & 0 \\ 0 & 0 & 1 & 0 \\ 0 & 0 & 0 & 1\end{matrix} ] [ \begin{matrix}1 & 0 & 0 & {a}_{i} \\ 0 & 1 & 0 & 0 \\ 0 & 0 & 1 & {d}_{i} \\ 0 & 0 & 0 & 1\end{matrix} ] \\ [ \begin{matrix}1 & 0 & 0 & 0 \\ 0 & cos {α}_{i} & - sin {α}_{i} & 0 \\ 0 & sin {α}_{i} & cos {α}_{i} & 0 \\ 0 & 0 & 0 & 1\end{matrix} ] \\ = [ \begin{matrix}cos {θ}_{i} & - sin {θ}_{i} cos {α}_{i} & sin {θ}_{i} sin {α}_{i} & {α}_{i} cos {θ}_{i} \\ sin {θ}_{i} & co {θ}_{i} cos {α}_{i} & - cos {θ}_{i} sin {α}_{i} & {α}_{i} sin {θ}_{i} \\ 0 & sin {α}_{i} & cos {α}_{i} & {d}_{i} \\ 0 & 0 & 0 & 1\end{matrix} ] ;\end{matrix}$$

aᵢ refers to a connecting rod length; αᵢ refers to a connecting rod torsion angle; dᵢ refers to a connecting rod distance; and θᵢ refers to a connecting rod rotation angle. The connecting rod length aᵢ is the distance between the axes of two joints, i.e., the length of a common perpendicular line between the axis zᵢ, and the axis zᵢ₋₁, and is measured along an xᵢ-axis direction. aᵢ is always positive; when the axes of the two joints are parallel, aᵢ=1ᵢ, and 1ᵢ is the length of the connecting rod; when the axes of the two joints are perpendicular, aᵢ=0. The connecting rod torsion angle αᵢ is an included angle between the axes of the two joints, i.e., the included angle between the axis zᵢ and the axis zᵢ₋₁, which is positive when rotating about the axis xᵢ from the axis zᵢ₋₁ to the axis zᵢ and meeting a right-hand rule. When the axes of the two joints are parallel, αᵢ=0; and when the axes of the two joints are perpendicular, αᵢ=90°. The connecting rod distance d₁ is the distance between the two connecting rods aᵢ and aᵢ₋₁, i.e., the distance between the axis xᵢ and the axis xᵢ₋₁, and is measured on the axis zᵢ₋₁. dᵢ is a constant for rotating joints, and is a variable for moving joints. The connecting rod rotation angle θᵢ is the included angle between the two connecting rods aᵢ and aᵢ₋₁, and is positive when rotating about the axis zᵢ₋₁ from the axis xᵢ₋₁ to the axis xᵢ and meeting the right-hand rule. θᵢ is a variable for the rotating joints, and is a constant for the moving joints.

Table 1 is a table of parameters D-H; and Table 2 is a value range of the connecting rod rotation angle θᵢ.

TABLE 1
Table of Parameters D-H

| Connecting rod | θᵢ/(°) | dᵢ/mm | aᵢ/mm | αᵢ/(°) |
|---|---|---|---|---|
| i = 0 | θ₀ | d₀ | a₀ | 0 |
| i = 1 | θ₁ | d₁ | 300 | 0 |
| i = 2 | θ₂ | 0 | 150 | 0 |

TABLE 2
Value Range of Connecting Rod Rotation Angle θᵢ

| θᵢ | θ₀ | θ₁ | θ₂ |
|---|---|---|---|
| Range of the | [−360, 360] | [120, 240] | [120, 210] |
| rotation angle | | | |

A transformation matrix of every adjacent connecting rods obtained from the above Equation and Table 1 is:

$${T}_{0} = [ \begin{matrix}cos {θ}_{0} & - sin {θ}_{0} & 0 & {a}_{0} cos {θ}_{2} \\ sin {θ}_{0} & cos {θ}_{0} & 0 & {a}_{0} sin {θ}_{2} \\ 0 & 0 & 1 & {d}_{0} \\ 0 & 0 & 0 & 1\end{matrix} ]$$

$${T}_{1} = [ \begin{matrix}cos {θ}_{1} & - sin {θ}_{1} & 0 & 300 cos {θ}_{1} \\ sin {θ}_{1} & cos {θ}_{1} & 0 & 300 sin {θ}_{1} \\ 0 & 0 & 1 & {d}_{1} \\ 0 & 0 & 0 & 1\end{matrix} ]$$

$${T}_{2} = [ \begin{matrix}cos {θ}_{2} & - sin {θ}_{2} & 0 & 150 cos {θ}_{2} \\ sin {θ}_{2} & cos {θ}_{2} & 0 & 150 sin {θ}_{2} \\ 0 & 0 & 1 & 0 \\ 0 & 0 & 0 & 1\end{matrix} ]$$

The transformation matrixes of each connecting rod are multiplied to obtain a transformation matrix ⁰T₃ of the intelligent spray nozzle as follows:

$${}_{}^{0}{T}{}_{3}^{} = {T}_{0} {T}_{1} {T}_{2} = [ \begin{matrix}{n}_{x} & {o}_{x} & {a}_{x} & {p}_{x} \\ {n}_{y} & {o}_{y} & {a}_{y} & {p}_{y} \\ {n}_{z} & {o}_{z} & {a}_{z} & {p}_{z} \\ 0 & 0 & 0 & 1\end{matrix} ] = [ \begin{matrix}{}_{}^{0}{R}{}_{r}^{} & p \\ 0 & 1\end{matrix} ] .$$

In the equation,

nₓ=c₀c₁c₂−s₀s₁c₂−s₀s₂c₀−s₀s₂c₁ n_{y}=s₀c₀c₁+s₁c₀c₂−s₀s₁s₂−s₂c₀c₁

n_{z}=0

oₓ=s₂c₀c₁+s₀s₁s₂−s₁c₀c₂−s₀s₂c₁ o_{y}=−s₀s₂c₁+s₂c₀c₁−s₀s₁s₂−c₀c₁s₂

o_{z}=0

aₓ=0 a_{y}=0

a_{z}=0

pₓ=150c₀c₁c₂−150s₀s₁c₂−150s₁s₂c₀−150s₀s₂c₁+300c₀²−300s₀²+a₀c₀

p_{y}=150s₀c₀c₁+150s₁c₀c₂−150s₀s₁s₂−150s₂c₀c₁+600s₀c₀+a₀s₀

p_{z}=d₀+d₁;

In the equation, sᵢ=sin θᵢ and cᵢ=cos θᵢ; and for example, s₁=sin θ₁ and c₁=cos θ₁.

The above are only preferred embodiments of the present application and not intended to limit the present application. Various modifications and changes can be made to the present application for those skilled in the Art. Any modification, equivalent substitution, improvement, etc. made within the spirit and principles of the present application shall be included in the protection scope of the present application.

We claim:

1. An MDOF (multi-degree-of-freedom) micro-lubrication intelligent spray head system for a CNC milling machine, comprising an annular rotating platform, a longitudinal telescopic part, a rotating part, an intelligent spray head mounting platform and an information acquisition system, wherein
the annular rotating platform comprises a rotating piece which rotates along a horizontal circumferential direction; a bottom of the rotating piece is connected with at least one longitudinal telescopic part; a lower end of the longitudinal telescopic part is connected with the rotating part; the rotating part rotates within a set angle range by taking a point connected with the longitudinal telescopic part as an axis; the intelligent spray head mounting platform is connected with the rotating part and moves along with the rotating part; and the information acquisition system is mounted on the intelligent spray head mounting platform.

2. The MDOF micro-lubrication intelligent spray head system for a CNC milling machine according to claim 1, wherein the annular rotating platform comprises a rotating platform housing, a rotating body, a stepping motor and a power transmission device;
the stepping motor is arranged inside the rotating platform housing, and is connected with the rotating body through the power transmission device to drive the rotating body to rotate.

3. The MDOF micro-lubrication intelligent spray head system for a CNC milling machine according to claim 1, wherein the longitudinal telescopic part comprises a telescopic cylinder and an extension piece; the extension piece comprises a fixed end and an extended end; the telescopic cylinder is connected with the annular rotating platform by the fixed end; a telescopic rod of the telescopic cylinder is connected with the extended end; a fixed end is arranged between the extended end and the fixed end of the extension piece; and the telescopic cylinder provides power to realize longitudinal extension of the extended end.

4. The MDOF micro-lubrication intelligent spray head system for a CNC milling machine according to claim 1, wherein two longitudinal telescopic parts are respectively fixed at both ends of the bottom of the annular rotating platform.

5. The MDOF micro-lubrication intelligent spray head system for a CNC milling machine according to claim 1, wherein the rotating part comprises a rotating cylinder and a mechanical arm; the rotating cylinder is connected with the longitudinal telescopic parts; the mechanical arm is fixed on a rotating disk of the rotating cylinder, a magnetic sensor is arranged on the rotating cylinder, and a rotating angle of the rotating disk is determined by the magnetic sensor.

6. The MDOF micro-lubrication intelligent spray head system for a CNC milling machine according to claim 5, wherein a spraying angle of the intelligent spray head is finely adjusted by the rotating cylinder.

7. The MDOF micro-lubrication intelligent spray head system for a CNC milling machine according to claim 5, wherein the mechanical arm is an L-shaped plastic steel frame.

8. The MDOF micro-lubrication intelligent spray head system for a CNC milling machine according to claim 7, wherein the L-shaped plastic steel frame is provided with a fixed end at each of an upper end and a lower end; an upper fixed end is a flange plate for connecting a rotating shaft of the rotating cylinder a lower part of the L-shaped plastic steel frame is a cross rod; and a screw hole for fixing the rotating cylinder is formed in the cross rod.

9. The MDOF micro-lubrication intelligent spray head system for a CNC milling machine according to claim 1, wherein the intelligent spray head mounting platform is connected with the rotating part and is provided with a platform connected with the telescopic cylinder.

10. The MDOF micro-lubrication intelligent spray head system for a CNC milling machine according to claim 1, wherein the information acquisition system comprises an infrared sensor, a single chip microcomputer and an information acquisition card; the infrared sensor acquires real-time signals of machining tools of the milling machine; and the information acquisition card transmits the information acquired by the infrared sensor to the single chip microcomputer, thereby optimizing a movement path of the equipment and realizing better tracking and spraying.
